(19) United States
(12) Patent Application Publication
(10) Pub. No.: US 2008/0219369 A1
(43) Pub. Date: Sep. 11, 2008

(54) ROBUST RATE, POWER AND PRECODER ADAPTATION FOR SLOW FADING MIMO CHANNELS WITH NOISY LIMITED FEEDBACK

(75) Inventors: Tianyu Wu, Hong Kong (CN); Vincent Kin Nang Lau, Hong Kong (CN)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: THE HONG KONG UNIVERSITY OF SCIENCE AND TECHNOLOGY, Hong Kong (CN)

(21) Appl. No.: 12/042,073

(22) Filed: Mar. 4, 2008

Related U.S. Application Data
(60) Provisional application No. 60/894,092, filed on Mar. 9, 2007.

(51) Int. Cl. H04L 27/28

(52) U.S. Cl. 375/260

(57) ABSTRACT

System and methodologies are provided herein for rate, power and precoder adaptation for slow fading MIMO communication channels with noisy limited feedback. To optimize a rate of successful information delivery from a wireless transmitter to a wireless receiver and to provide robustness to channel noise, a joint design and optimization technique is utilized to provide optimal power, rate, and precoding adaptation policies for use by a wireless transmitter and an optimal feedback scheme and index assignment mapping for use by a wireless receiver. Additionally, various optimization and design techniques described herein are performed using a low-complexity online adaptation coupled with an offline optimization design.

### CROSS-REFERENCE

This application claims the benefit of U.S. Provisional Patent Application Ser. No. 60/894,092, filed on Mar. 9, 2007, entitled “ROBUST RATE, POWER AND PRECODER ADAPTATION FOR SLOW FADING MIMO CHANNELS WITH NOISY LIMITED FEEDBACK.”

### TECHNICAL FIELD

The present disclosure relates generally to wireless communications systems, and more particularly to techniques for rate, power and precoder adaptation and optimization for wireless communication systems.

### BACKGROUND

Conventionally, channel state information of transmitter (CSIT) is important for achieving high spectral efficiency in multiple-input multiple-output (MIMO) wireless communication systems, such as those that operate using slow fading channels. With perfect and full CSIT knowledge, ergodic capacity can be achieved through rate adaptation even for slow fading channels. In frequency division duplexing (FDD) communication systems, CSIT can be obtained at a transmitter through feedback. In practice, however, only a limited number of bits can be allocated to carry CSIT feedback. Moreover, this limited CSIT feedback may suffer from noise on a feedback channel over which it is communicated. This noise can cause uncertainty in the CSIT at the transmitter, which in turn can cause transmitted packets to be corrupted if the rate at which the packets are transmitted exceeds the instantaneous mutual information available at the communication system. As generally known in the art, this packet corruption can be referred to as “packet outage.”

Conventional designs addressing limited feedback for MIMO channels are somewhat limited, focusing on precoder design with noiseless limited feedback, and thus do not fully address the problem as described above. For example, due to the fact that these conventional designs address only precoder design with noiseless limited feedback, the issue of potential packet outage is ignored. Furthermore, no rate adaptation is considered in conventional systems, which is beneficial to control packet outage in slow fading channels. As a result, these conventional systems can experience significant performance degradation when noisy limited feedback is encountered in slow fading channels, since erroneous CSIT feedback can make the transmitter transmit a packet with an incorrect adaptation mode, thereby decreasing the throughput of the communication system and/or causing packet errors. Accordingly, there exists a need in the art for techniques for addressing packet outage in slow fading MIMO channels with noisy limited feedback.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The present disclosure provides systems and methodologies for rate, power and precoder adaptation for wireless communication systems such as MIMO communication systems with slow fading channels and noisy limited feedback. In accordance with various aspects described herein, a robust joint rate adaptation policy (codebook), precoder adaptation policy, and/or channel state information of receiver (CSIR) feedback strategy can be determined and implemented to optimize system goodput under a target packet outage constraint for slow fading MIMO channels between one or more transmitters and one or more receivers, wherein limited channel state information is communicated via a noisy feedback channel.

Moreover, optimization of system goodput can be converted to an equivalent “maximin” equation, which addresses error constraints introduced by limited feedback received on a noisy feedback channel. Additionally and/or alternatively, various techniques described herein can be performed using a low-complexity online adaptation coupled with offline optimization design. Offline optimization can be performed, for example, by utilizing one or more techniques for performing vector quantization with a modified distortion metric.

To the accomplishment of the foregoing and related ends, certain illustrative aspects of the claimed subject matter are described herein in connection with the following description and the annexed drawings. These aspects are indicative, however, of but a few of the various ways in which the principles of the claimed subject matter can be employed. The claimed subject matter is intended to include all such aspects and their equivalents. Other advantages and novel features of the claimed subject matter can become apparent from the following detailed description when considered in conjunction with the drawings.

### BRIEF DESCRIPTION OF THE DRAWINGS

FIG. 1 is a high-level block diagram of a wireless communication system in accordance with various aspects.

FIG. 2 is a block diagram of an example wireless communication system in accordance with various aspects.

FIG. 3 is a block diagram of a system for rate, power, precoder, and feedback adaptation in a wireless communication system in accordance with various aspects.

FIG. 4 is a block diagram of an example component that facilitates rate, precoder, and feedback strategy optimization for a wireless communication system in accordance with various aspects.

FIG. 5 illustrates example outage probability data for an example wireless communication system.

FIG. 6 is a flowchart of a method for adapting parameters of stations operating in a wireless communication system.

FIG. 7 is a flowchart of a method for facilitating optimized communication in a wireless communication system.

FIGS. 8-9 are flowcharts of respective methods for jointly optimizing rate adaptation, precoder adaptation, and feedback strategies.

10 is a block diagram of an example operating environment in which various aspects described herein can function.

FIG. 11 illustrates an overview of a wireless network environment suitable for service by various aspects described herein.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, the methods and apparatus of the claimed subject matter, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the claimed subject matter. The components may communicate via local and/or remote processes such as in accordance with a signal having one or more data packets (e.g., data from one component interacting with another component in a local system, distributed system, and/or across a network such as the Internet with other systems via the signal).

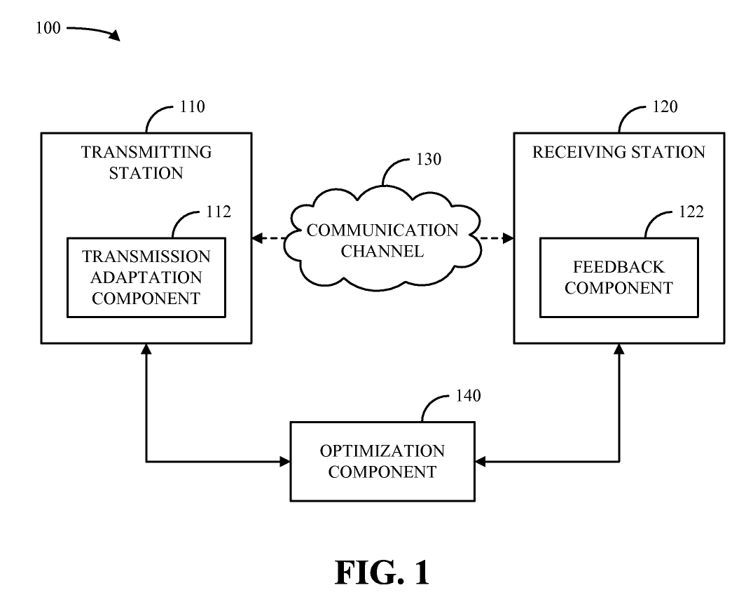

Referring to FIG. 1, a high-level block diagram of a wireless communication system 100 in accordance with various aspects presented herein is illustrated. In accordance with one aspect, system 100 can include one or more stations 110 and 120 that can communicate data, control signaling, and/or other information with each other over a wireless communication link or channel 130. While station 110 is referred to in FIG. 1 and herein as a “transmitting station” and station 120 is referred to in FIG. 1 and herein as a “receiving station,” it should be appreciated that information can be communicated in system 100 from station 110 to station 120 as well as from station 120 to station 110.

It should be appreciated that stations 110 and/or 120 can comprise and/or provide the functionality of a wireless terminal, which can be connected to a computing device such as a laptop computer or desktop computer and/or self-contained devices such as a cellular telephone, a personal digital assistant (PDA), or another suitable device. A wireless terminal can also be called a system, subscriber unit, subscriber station, mobile station, mobile, remote station, remote terminal, access terminal, user terminal, user agent, user device, user equipment, etc. Additionally and/or alternatively, one or more stations 110 and/or 120 in the system 100 can comprise and/or provide the functionality of a wireless access point or base station by, for example, serving as a router between one or more other stations and a wireless access network associated with the access point.

In one example, stations 110 and 120 can include multiple antennas such that communication can be conducted between stations 110 and 120 over a MIMO communication link. It is to be appreciated that such communication can be conducted according to any now-existing or future communication techniques and/or combinations thereof. Additionally, as used herein, “forward link” or “downlink” communication refers to communication from a transmitting station 110 to a receiving station 120, while “reverse link” or “uplink” communication refers to communication from a receiving station 120 to a transmitting station 110.

In accordance with one aspect, a receiving station 120 in system 100 can include a feedback component 122. In one example, the feedback component 122 at the receiving station 120 can determine information relating to the state of the communication channel 130 between stations 110 and 120 as it is available to the station 120 (e.g., CSIR) and relay this information as CSIT feedback to the transmitting station 110. Based on this CSIT feedback, a transmission adaptation component 112 at the transmitting station 110 can select one or more adaptation policies for communication with the receiving station 120. For example, the receiving station 120 can transmit CSIT information to the transmitting station 110 over a noisy CSIT feedback channel that carries C_{fb} bits/packet. Based on a received CSIT signal from the receiving station 120, the transmitting station 110 can employ the transmission adaptation component 112 to select a transmission mode from a pre-designed adaptation codebook or adaptation policy. In one example, this adaptation codebook or policy can include precoder matrix, transmission rate and transmission power entries for 2^{C}^{_{jb}} cases, which respectively correspond to each possible value for a CSIT signal provided by the receiving station 120.

Conventionally, CSIT feedback has played an important role in enhancing the performance of MIMO systems, such as those that utilize slow fading channels. For example, based on CSIT, a transmitting station 110 can increase forward link capacity by performing spatial and temporal power adaptation and/or spatial precoding adaptation. In the particular case of slow fading communication channels 130 between stations 110 and 120, channel fading can remain quasi-static within an encoding frame, thereby causing such slow fading channels to be non-ergodic. As a result, packet errors (e.g., packet outage) can be experienced between stations 110 and 120 if a data rate at which information is transmitted on a given channel 130 exceeds the instantaneous mutual information available for the channel 130, even if powerful channel coding is utilized. However, when perfect and full CSIT is available, this potential packet outage can be avoided, and ergodic capacity can be achieved, by applying rate adaptation due to the fact that the instantaneous mutual information is known to the transmitting station 110.

In accordance with one aspect, CSIT can be obtained at the transmitting station 110 through feedback received from the receiving station 120 via a feedback component 122. In practice, however, only a limited number of bits can be allocated to carry CSIT feedback. Moreover, this limited CSIT feedback may suffer from noise on a feedback channel through which it is communicated, resulting in noisy limited feedback. Noisy limited CSIT feedback can cause uncertainty of channel state information at the transmitting station 110, which can in turn lead to uncertainty regarding the instantaneous mutual information at the transmitting station 110. As a result, packets transmitted by the transmitting station 110 can be corrupted (e.g., packet outage can be experienced) if the transmitted rate of the packets exceeds the instantaneous mutual information.

Conventional adaptation techniques focus primarily on MIMO precoder design with noiseless limited feedback and ignore the issue of potential packet outage. As a result, such conventional techniques do not fully address the problems presented by limited feedback for MIMO channels as described above. Furthermore, rate adaptation is not considered in such conventional techniques, which as noted above is also beneficial for controlling packet outage in slow fading channels. It can be appreciated that the performance degradation for conventional naive designs designed for error-free limited feedback is significant when noisy limited feedback over slow fading channels is considered. For example, erroneous CSIT feedback can cause a transmitting device to transmit a packet with an incorrect adaptation mode (e.g., an adaptation mode that does not match the actual CSI), which in turn can decrease the throughput of the forward MIMO link and/or cause packet outage.

In light of the above, system 100 can include an optimization component 140 in accordance with various aspects to address packet outage in the presence of slow fading MIMO channels and noisy limited feedback, thereby improving the overall performance of system 100. In one example, the optimization component can be communicatively connected to the transmitting station 110 and/or the receiving station 120, and can optimize system 100 by jointly initializing and/or adjusting various parameters of the transmitting station 110 and/or the receiving station 120. These parameters can include, for example, power, rate, and/or precoding parameters utilized by the transmitting station 110 and/or feedback parameters utilized by the receiving station 120. It should be appreciated, however, that while the optimization component 140 is illustrated in system 100 as a single distinct entity from the transmitting station 110 and the receiving station 120, the optimization component 140 can be implemented wholly or in part at the transmitting station 110, the receiving station 120, and/or any other suitable entity in the system 100. Further, it should be appreciated that various aspects of the functionality of the optimization component 140 can be distributed between a plurality of different devices. By way of example, power, rate, and precoding adaptation functionality of the optimization component 140 can be implemented at the transmitting station 110, and feedback adaptation functionality of the optimization component 140 can be implemented at the receiving station 120. In such an example, the stations 110 and 120 can communicate directly with each other and/or indirectly with an external entity to jointly optimize their respective communication parameters.

In accordance with one aspect, the optimization component 140 can utilize system goodput, e.g., bits per second per Hertz (b/s/Hz) successfully delivered to the receiving station 120, as a performance measure in order to take potential packet errors and/or packet outage into account. Furthermore, the optimization component 140 can address various technical issues associated with obtaining an error-resilient limited CSIT feedback design framework. For example, it can be observed that the rate adaptation, power adaptation, and precoder adaptation policies employed by a transmitting station 110 are coupled together with respect to the overall achievable goodput of the system 100. As a result, the optimization component 140 can jointly design such policies in order to ensure that optimal precoder matrix, transmission rate, and transmit power parameters are utilized based on a given received CSIT feedback signal.

In addition, it can further be appreciated that the manner in which a receiving station 120 generates CSIT feedback given a CSIR can also affect the goodput of the system 100 and that the CSIT feedback strategy of the receiving station 120 is accordingly also tightly coupled with the design of rate, power and precoder adaptation policies at the transmitting station 110. Thus, such parameters of the receiving station 120 can be designed by the optimization component 140 together with parameters of the transmitting station 110 to ensure generation of optimal CSIT feedback signals in the system 100.

As another example, it can be appreciated that when noisy feedback is considered, a limited CSIT index received at the transmitting station 110 may not always be equal to the index provided by the receiving station 120. Thus, to mitigate these effects, the optimization component 140 can take the design of optimal rate, power and precoder adaptation policies at the transmitting station 110 and the design of an optimal partitioning at the receiving station 120 into consideration together to ensure robust system performance even in the presence of noisy limited feedback.

Additionally and/or alternatively, the optimization component 140 can consider requirements of various applications for respective target frame error rates (FERs). This can be accomplished by, for example, enabling the maintenance of a certain required target FER or related packet outage probability as required by respective applications consuming information communicated within system 100.

In accordance with various aspects described herein, system 100 can be utilized to overcome the shortcomings of conventional communication systems by considering packet outage in slow fading MIMO channels with noisy limited feedback. The optimization component 130 can provide an integrated framework for robust joint rate, power and precoder adaptation policy (e.g., codebook) design as well as CSIT feedback strategy design for slow fading MIMO channels with noisy limited feedback in order to maximize the goodput of the system 100. In one example, the goodput of the system 100 can be maximized under a target packet outage constraint. Accordingly, optimization can be conducted by converting the optimization problem to an equivalent “maximin” problem, as will be described in further detail infra.

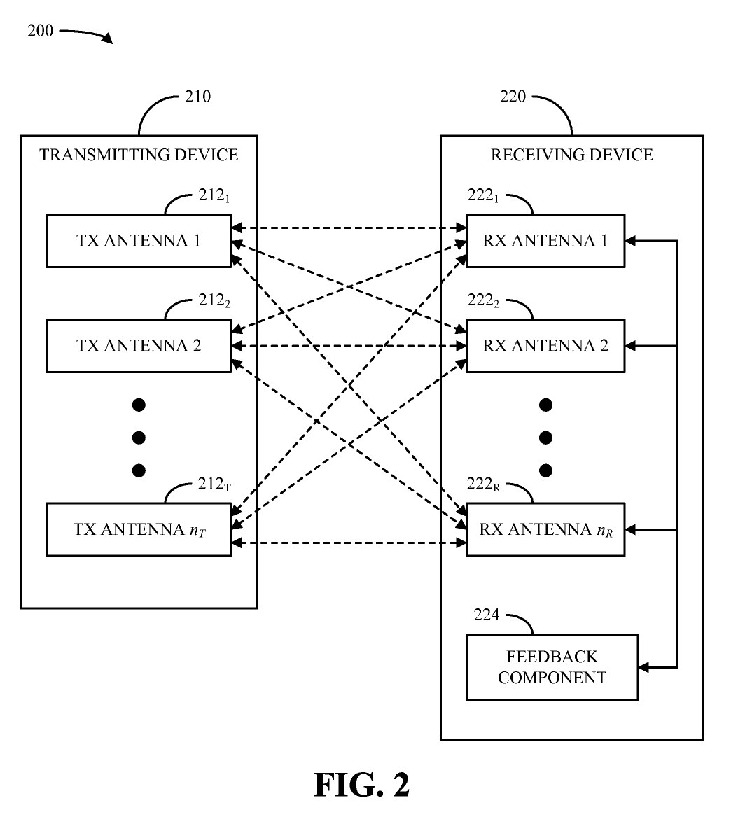

Turning now to FIG. 2, an example wireless communication system 200 in accordance with various aspects is illustrated. In one example, system 200 is a point-to-point MIMO communication system between one or more transmitting devices 210 and one or more receiving devices 220. System 200 can, in accordance with one aspect, be based on a forward MIMO fading channel model, wherein n_{T} transmit antennas 212 at a transmitting device 210 are utilized to communicate with n_{R} receive antennas 222 at a receiving device 220. It should be appreciated, however, that while device 210 and antennas 212 are labeled for transmitting and device 220 and antennas 222 are labeled for receiving in FIG. 2, system 200 could additionally and/or alternatively be utilized to facilitate communication from one or more receive antennas 222 at the receiving device 220 to one or more transmit antennas at the transmitting device 210. Further, it should be appreciated that system 200 could include any suitable number of transmitting devices 210 and/or receiving devices 220, each of which could respectively include any appropriate number of transmit antennas 212 and/or receive antennas 222.

In accordance with one aspect, the forward MIMO channel between the transmitting device 210 and the receiving device 220 can be modeled as follows:

Y=HX+Z, (1)

where X is an n_{T}×1 transmit symbol, Y denotes an n_{R}×1 received symbol, H is an n_{R}×n_{T} complex channel state matrix, and Z represents n_{R}×1 complex Gaussian channel noise with covariance matrix ε[ZZ^{†]=I}ₙ_{_{R}}. In one example, it can be assumed that the transmit antennas 212 and receive antennas 222 are sufficiently far apart such that each element of H. e.g., h_{i,j}, is independent and identically distributed (i.i.d.). In another example, the channel matrix H can be normalized without loss of generality by assuming ε[|h_{i,j}|²]=1, where ε[.] denotes expectation over all channel realizations.

In accordance with another aspect, system 200 utilizes slow fading channels, wherein the channel fading matrix H remains quasi-static throughout an encoding frame. It can be appreciated that such a channel model can be applied to pedestrian mobility (e.g., ˜5 km/hr) and/or other cases having a packet duration on the order of 500 ns. Examples of such cases include wireless fidelity (Wi-Fi), beyond third generation (B3G) technologies, and/or other similar technologies. In one example, a communication channel between the transmitting device 210 and the receiving device 220 can additionally experience quasi-static fading and noisy limited feedback. As a result, uncertainty can be present regarding the instantaneous mutual information at the transmitting device 210, which is a function of the instantaneous CSI. This can lead to potential packet errors due to channel outage, despite the application of powerful channel coding, in the event that a transmitted data rate exceeds the instantaneous mutual information due to such uncertainty.

In one example, to capture the issue of potential packet outage, the instantaneous goodput ρ of system 200 can be defined as follows:

ρ=R·1[R<C(H)], (2)

where R is the data rate of a given packet, C(H) is the instantaneous mutual information, and 1(A) is an indicator function that is equal to 1 if the event A is true and 0 otherwise. Further, the average goodput of system 200 can be given by ε[ρ] where the expectation is over realizations of CSI. In this regard, the average system goodput measures the average b/s/Hz successfully delivered to the receiving device 220 without error and is utilized as a performance objective in connection with the optimization framework described herein.

As FIG. 2 further illustrates, the receiving device 220 can include a feedback component 224 for determining and relaying CSI to the transmitting device 210. In one example, the CSI can be assumed to be perfectly estimated at the receiving device 220 and fed back to the transmitting device 210 through a noisy feedback channel with a limited feedback capacity constraint of C_{fb} bits per encoding frame. Thus, given a maximum of C_{fb} bits of feedback allowable per encoding frame, the channel matrix (CSIR) H can be mapped into N=2^{C}^{_{fb}} indices K at the receiving device 220 and fed back as CSIT indices to the transmitting device 210 via the feedback component 224 through the feedback channel. However, due to potential feedback errors, CSIT feedback indices L received at the transmitting device may not always be the same as indices K. As generally used herein, the indices K are referred to as FeedBack at Receiver (FBR), and the indices L are referred to as FeedBack at Transmitter (FBT). In one example, the possible sets of FBR and FBT can both have cardinalities of N, thereby requiring C_{fb} bits for encoding the FBR.

In one example, mapping of the CSIR H to the FBR K at the receiving device 220 can be represented by the feedback function f:Cⁿ^{_{R}}^{×n}^{_{T}}→{1, . . . ,N} in the following manner:

K=f(H). (3)

Moreover, it can be appreciated that any general deterministic feedback function f(.) can be characterized by a partition on the CSIR space H={H₁, . . . ,H_{N}}. As used herein, it should be appreciated that a partition on a region is a set of mutually exclusive sub-regions such that the union of all the subregions gives the original region. Furthermore, if the CSIR H belongs to the i-th partition region Hᵢ, the corresponding FBR can be given by K=i. This property can be expressed as follows:

f(H)=i if H ∈ Hᵢ i ∈{1, . . . ,N}. (4)

In accordance with one aspect, the receiving device 220 and the transmitting device 210 can engage in transmissions of noisy limited CSIT feedback where L may not equal to K. In one example, a noisy limited feedback channel between devices 210 and 220 can be characterized by a N-input N-output discrete memory-less channel (DMC-FB) with M⁽ⁱⁿ⁾ as the input and M^{(out)} as the output of the DMC-FB. Thus, it should be appreciated that the cardinalities of M⁽ⁱⁿ⁾ and M^{(out)} are both N. Based on these definitions, the channel transition matrix of the DMC-FB, {Pₘ_{ₗ}ₘ_{ₖ}^{DMC-FB}} can be given as follows:

Pₘ_{ₗ}ₘ_{ₖ}^{DMC-FB}=Pr[M^{(out)}=mₗ|M⁽ⁱⁿ⁾=mₖ]∀mₗ ∈ M^{(out)}, mₖ ∈ M⁽ⁱⁿ⁾. (5)

In accordance with another aspect, the channel transition matrix P^{DMC-FB} can depend on the modulation level, encoding scheme, and/or average feedback signal-to-noise ratio (SNR) by which the feedback channel between devices 210 and 220 is characterized. By way of specific, non-limiting example, if one 8-phase shift keying (8-PSK) modulation symbol is used in the feedback channel to deliver a 3-bit FBR and the average SNR for feedback is 10 dB, M⁽ⁱⁿ⁾ and M^{(out)} can be given by the respective 8-PSK constellation points and P^{DMC-FB} can be given by the following:

$${P}^{DMC - FB} = [ \begin{matrix}0.760 & 0.111 & 0.007 & 0.0016 & 0.0008 & 0.0016 & 0.007 & 0.111 \\ 0.111 & 0.760 & 0.111 & 0.007 & 0.0016 & 0.0008 & 0.0016 & 0.007 \\ & & & ⋰ & & & & \\ 0.111 & 0.007 & 0.0016 & 0.0008 & 0.0016 & 0.007 & 0.111 & 0.760\end{matrix} ] . \qquad ( 6 )$$

In accordance with a further aspect, a stochastic relationship can exist in system 200 between FBR K and FBT L. To characterize this relationship, a CSIT index transition matrix P^{CSIT}={Pᵢⱼ^{CSIT}} can be defined as follows:

Pᵢⱼ^{CSIT}=Pr[L=j|K=i] i,j ∈{1, . . . ,N}. (7)

It can be observed from Equation (7) that the transition matrix P^{CSIT} can be determined by two parts, namely the DMC-FB Pₘ_{ₗ}ₘ_{ₖ}^{DMC-FB} and a modulation index mapping ξ(.). In one example, the modulation index mapping function ξ(.) is a one-to-one mapping from the FBR K to the input of the feedback channel M⁽ⁱⁿ⁾, M⁽ⁱⁿ⁾=ξ(K). Additionally and/or alternatively, the DMC-FB channel Pₘ_{ₗ}ₘ_{ₖ}^{DMC-FB}; can be characterized by the noisy feedback channel characteristic. In one example, given an index mapping function ξ(.) and a DMC-FB P^{DMC-FB}, the CSIT index transition matrix P^{CSIT} can be given by the following:

$${P}_{ij}^{CSIT} = Pr [ ℒ = j \vert 𝒦 = i ] = {P}_{ξ ( i ) , ξ ( j )}^{DMC - FB} i , j ∈ \{ 1 , … , N \} . \qquad ( 8 )$$

Techniques for generating an optimal design for the index mapping function ξ(.) are discussed in further detail infra.

The packet outage probability and average goodput of one or more MIMO slow fading channels in system 200 can be derived in terms of rate, power and precoder adaptation policies implemented at the transmitting device 210, a CSIT feedback strategy implemented at the receiving device 220, and a CSIT limited feedback model of system 200. As a specific example, the transmitting device 210 can be characterized as a generic adaptive MIMO transmitter and the receiving device 220 can be characterized as a MIMO receiver which can provide limited noisy feedback to the transmitting device 210. In such an example, CSI H can be estimated at the receiving device based on preambles positioned the beginning of respective packet transmissions. Further, the CSIR space at the receiving device 220 can be partitioned into N regions {H_{∞}, . . . ,H_{N}}, which can be labeled by FBR K ∈{ 1, . . . ,N} such that a FBR K=i is generated if the CSIR H ∈ Hᵢ.

At the transmitting device 210, a general rate adaptation policy R={R₁, . . . ,R_{N}} can be defined by a table (or codebook) of N data rates. Similarly, a general power and precoder adaptation policy Q={Q₁, . . . ,Q_{N}} can be defined by a table (or codebook) of N positive semi-definite matrices. In one specific, non-limiting example, the precoder matrix Qₙ can be decomposed into a diagonal power allocation matrix and a unitary spatial multiplexing matrix such that the precoding and power adaptation policies can be represented by a common matrix Qₙ. Based on a rate adaptation policy R and a precoder adaptation policy Q and given FBT L=j, a packet can be transmitted by the transmitting device 210 with data rate Rⱼ ∈ R and precoding matrix Qⱼ ∈ Q. In one example, information comprising the packet can be encoded independently by n_{T} channel encoders at the transmitting device 210 at a total rate of Rⱼ to form an n_{T}×1 vector of encoded symbols T=[Tₗ , . . . ,Tₙ_{_{T}}]^{H}. The transmitting device 210 can then perform power control and spatial multiplexing (corresponding to Qⱼ) for the vector T to produce an n_{T}×1 vector of transmitted symbols X. The vector X can be expressed as follows:

X=WⱼΛⱼT, (9)

where Wⱼ is a unitary spatial multiplexing matrix and Λⱼ is a diagonal power allocation matrix derived from Qⱼ according to:

Qⱼ=Wⱼ^{H}Λⱼ²Wⱼ. (10)

Based on the above, the instantaneous mutual information of the MIMO link between the encoder outputs T and the channel outputs Y can be given by:

Cᵢₙₛₜ(H)=log ₂|Iₙ_{_{R}}+HQⱼH^{H}|, (11)

where the encoded symbols T are normalized to have unit covariance ε[TT^{H}]=Iₙ_{_{T}}.

In accordance with one aspect, due to potential CSIT feedback errors, the FBT L can be considered as a random variable conditioned on the FBR K=i. Accordingly, it can be appreciated that Pr[L=j|K=i]=Pᵢⱼ^{CSIT}. As a result, the average goodput of system 200, which represents the average data rate successfully received by the receiving device 200 and can be represented as ρ̅=ε[ρ], can be expressed in terms of the index mapping ξ, the CSIT feedback strategy H, the rate adaptation policy R, and the power and precoder adaptation policy Q as follows:

$$\begin{matrix}\overline{ρ ( ξ , ℋ , ℛ , 𝒬 )} = {E}_{H} [ R \cdot 1 ( R < {C}_{inst} ( H , Q ) ) ] \\ = {\sum }_{i = 1}^{N} Pr ( H ∈ {ℋ}_{i} ) {\sum }_{j = 1}^{N} {P}_{ij}^{CSIT} \cdot \\ {E}_{H ∈ {ℋ}_{i}} [ {R}_{j} \cdot 1 ( {R}_{j} < {C}_{inst} ( H , {Q}_{j} ) ) \vert H ∈ {ℋ}_{i} ] \\ = {\sum }_{i = 1}^{N} {\sum }_{j = 1}^{N} {R}_{j} \cdot Pr ( {log}_{2} \vert {I}_{{n}_{R}} + {HQ}_{j} {H}^{H} \vert > \\ {R}_{j} \vert H ∈ {ℋ}_{i} ) Pr [ H ∈ {ℋ}_{i} ] {P}_{ij}^{CSIT} .\end{matrix} \qquad ( 12 )$$

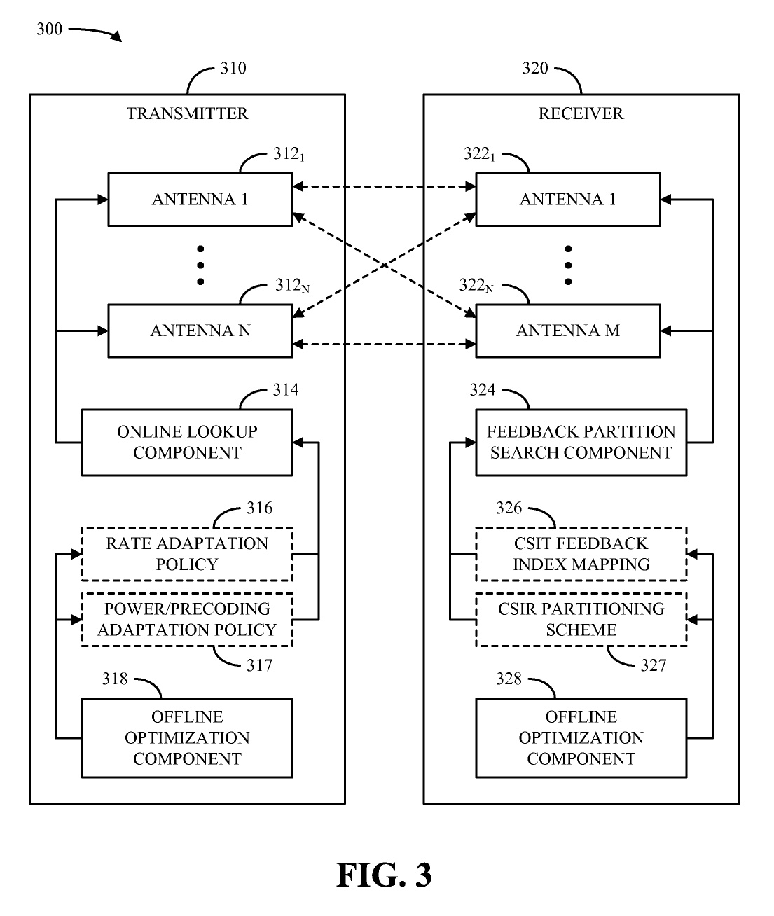

Referring to FIG. 3, a system 300 for rate, power, precoder, and feedback adaptation in a wireless communication system is provided. As FIG. 3 illustrates, system 300 can include one or more transmitters 310 and one or more receivers 320, which can communicate using respective antennas 312 and 322. In accordance with one aspect, transmitter 310 and/or receiver 320 can implement a design framework for noisy limited feedback by formulating such design as an optimization problem.

In one example, a transmitters 310 and/or receivers 320 in system 300 can implement an online algorithm and an offline parameter optimization for implementing the noisy limited feedback design. Online algorithms implemented by a transmitter 310 and/or receiver 320 can have low implementation complexity and involve only a table lookup operation and/or a partition search operation. For example, a transmitter 310 can utilize an online lookup component 314 to obtain a suitable power, rate, and precoding parameters for transmission to a receiver 320 from a predetermined rate adaptation policy 316 and/or power and precoding adaptation policy 317. Similarly, a receiver 320 can utilize a feedback partition search component 324 to obtain an appropriate CSIR partition and corresponding CSIT index from a predetermined CSIT feedback index mapping 326 and/or CSIR partitioning scheme 327. Offline parameter optimizations can be performed by, for example, respective offline optimization components 318 and 328 at a transmitter 310 and/or receiver 320, and can involve selection of an optimal rate adaptation policy or codebook 316, expressed as R={R₁, . . . ,R_{N}}, and/or power and spatial multiplexing weights adaptation policy or codebook 317, expressed as Q={Q₁, . . . ,Q_{N}}, at the transmitter 310 and/or a CSIT feedback index mapping 326, expressed as ξ(.), and/or CSIR partitioning 327, expressed as H={H₁, . . . ,H_{N}}, at the receiver 320. In accordance with one aspect, the functionality of the respective online components 314 and 324 and the respective offline optimization components 318 and 328 at the transmitter 310 and receiver 320 can be implemented wholly or in part by the transmitter 310 and/or receiver 320 or by an external device (e.g., an external optimization component 130).

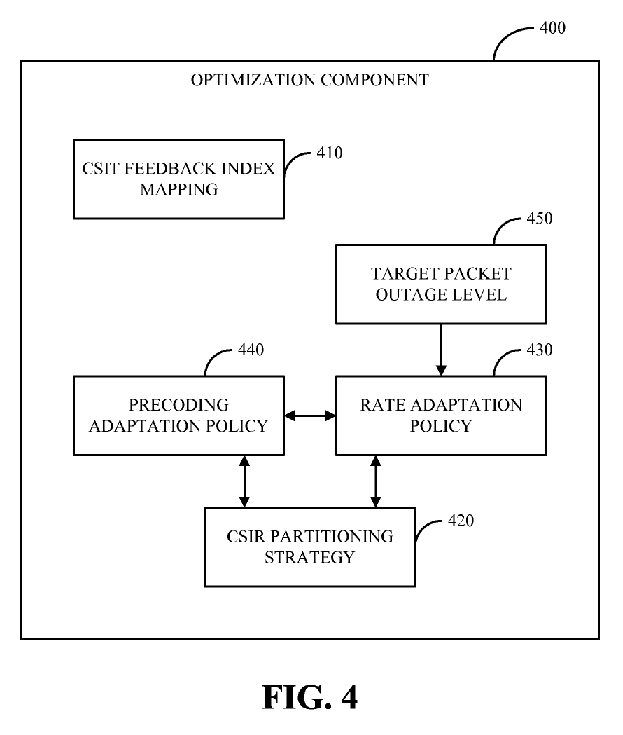

Referring now to FIG. 4, a block diagram of an example optimization component 400 that facilitates rate, precoder, and feedback strategy optimization for a wireless communication system is provided. The optimization component 400 can be implemented, for example, by one or more transmitting devices and/or receiving devices in a wireless communication system, one or more external entities in the wireless communication system, or a combination thereof.

In accordance with one aspect, based on the channel and feedback models described supra, the optimization component 400 can facilitate optimization of a communication system with noisy limited feedback by utilizing at least the following optimization problem. Particularly, for a system having a limited feedback capacity (e.g., C_{fb} bits per packet), the optimization component 400 can determine an optimal CSIR index mapping 410 (e.g., ξ*), CSIR partitioning 420 (e.g., H*), rate adaptation policy or codebook 430 (e.g., R*), and power and precoder adaptation policy or codebook 440 (e.g., Q*) such that the average system goodput ρ̅(̅ξ̅,̅H̅,̅R̅,̅Q̅)̅ is optimized under a target packet outage probability constraint 450 (e.g., ε) and an average transmit power constraint P₀. This optimization problem can be expressed as follows:

$$\begin{matrix}( {ξ}^{*} , {ℋ}^{*} , {ℛ}^{*} , {Q}^{*} ) = \text{arg} {max}_{ξ , ℛ , Q , ℋ} {\sum }_{i = 1}^{N} {\sum }_{j = 1}^{N} {R}_{j} \cdot Pr [ {log}_{2} \vert {I}_{{n}_{R}} + {HQ}_{j} {H}^{H} \vert > {R}_{j} \vert H ∈ {ℋ}_{i} ] Pr [ H ∈ {ℋ}_{i} ] {P}_{ij}^{CSIT} , \\ such that & ( 13 ) \\ \begin{matrix}\overline{{P}_{tx}} = {\sum }_{i = 1}^{N} tr ℰ [ {XX}^{H} \vert H ∈ {ℋ}_{i} ] Pr [ H ∈ {ℋ}_{i} ] \\ = {\sum }_{j = 1}^{N} {\sum }_{i = 1}^{N} {trQ}_{j} Pr [ H ∈ {ℋ}_{i} ] {P}_{ij}^{CSIT} \\ \leq {P}_{0}\end{matrix} \\ and & ( 14 ) \\ \overline{{P}_{out}} ( j ) = \frac{\begin{matrix}{\sum }_{i = 1}^{N} Pr [ {log}_{2} \vert {I}_{{n}_{R}} + {HQ}_{j} {H}^{H} \vert < \\ {R}_{j} \vert H ∈ {ℋ}_{i} ] Pr [ H ∈ {ℋ}_{i} ] {P}_{ij}^{CSIT}\end{matrix}}{{\sum }_{i = 1}^{N} Pr [ H ∈ {ℋ}_{i} ] {P}_{ij}^{CSIT}} = ɛ . & ( 15 )\end{matrix}$$

In accordance with one aspect, the optimization component 400 can initially select an optimal CSIT feedback index mapping 410 in the following manner. It can be appreciated that, for any CSIT index assignment function ξ(.), Q^{O}(ξ), R^{O}(ξ) and H^{O}(ξ) can be used to denote the corresponding optimizing precoding adaptation, rate adaptation and CSIR partitioning strategies. Thus, Q^{O}, R^{O} and H^{O} are implicit functions of the given CSIT index mapping ξ(.), and as a result,

$$( {𝒬}^{O} ( ξ ) , {ℛ}^{O} ( ξ ) , {ℋ}^{O} ( ξ ) ) = \text{arg} {max}_{𝒬 , ℛ , ℋ} \overline{ρ ( ξ , 𝒬 , ℛ , ℋ )} .$$

Based on this property, it can be observed that for any CSIT index mapping functions ξ_{A}(.) and ξ_{B}(.), the following expression holds:

$$\overline{ρ ( {ξ}_{A} , {𝒬}^{O} ( {ξ}_{A} ) , {ℛ}^{O} ( {ξ}_{A} ) , {ℋ}^{O} ( {ξ}_{A} ) )} = \overline{ρ ( {ξ}_{B} , {𝒬}^{O} ( {ξ}_{B} ) , {ℛ}^{O} ( {ξ}_{B} ) , {ℋ}^{O} ( {ξ}_{B} ) )} . \qquad ( 16 )$$

Equation (16) can be proven as follows. First, it should be appreciated that simultaneously changing an index mapping ξ and the respective orders of {Q}, {R} and {H} results in an equivalent system design. For example, in the case of 1-bit feedback, the design (ξ₁,{Q₁,Q₂},{R₁,R₂},{H₁,H₂}) is equivalent to the design (ξ₂,{Q₂,Q₁},{R₂,R₁},{H₁,H₂}), where ξ₁ is the natural mapping {1,2}→{1,2} and ξ₂ exchanges the order using the mapping {1,2}→{2,1}. Moreover, it can be appreciated that an index mapping ξ_{A} can be changed to a second index mapping ξ_{B} using index exchanging. A function T_{AB}(.) can be defined as the index exchange function from ξ_{A} to ξ_{B}, such that ξ_{B}(i)=T_{AB}(ξ_{A}(i)) for any index i. Therefore, it can be seen that design (ξ_{A},{Q^{O}(ξ_{A})ᵢ},{R^{O}(ξ_{A})ᵢ},{H^{O}(ξ_{A})ᵢ}) is equivalent to design (ξ_{B},{Q^{O}(ξ_{A})_{T}_{_{AB}}₍ᵢ₎},{R^{O}(ξ_{A})_{T}_{_{AB}}₍ᵢ₎},{H^{O}(ξ_{A})_{T}_{_{AB}}₍ᵢ₎}) which indicates the following:

$$\overline{ρ ( {ξ}_{A} , {𝒬}^{O} ( {ξ}_{A} ) , {ℛ}^{O} ( {ξ}_{A} ) , {ℋ}^{O} ( {ξ}_{A} ) )} = \overline{ρ ( \begin{matrix}{ξ}_{B} , \{ {{Q}^{O} ( {ξ}_{A} )}_{{T}_{AB} ( i )} \} , \\ \{ {{R}^{O} ( {ξ}_{A} )}_{{T}_{AB} ( i )} \} , \\ \{ {{ℋ}^{O} ( {ξ}_{A} )}_{{T}_{AB} ( i )} \}\end{matrix} )} \leq \overline{ρ ( {ξ}_{B} , {𝒬}^{O} ( {ξ}_{B} ) , {ℛ}^{O} ( {ξ}_{B} ) , {ℋ}^{O} ( {ξ}_{B} ) )} . \qquad ( 17 )$$

The inequality utilized in the final step of Equation (17) is due to the fact that O^{O}(ξ_{B}), R^{O}(ξ_{B}), and H^{O}(ξ_{B}) are the optimal design for index assignment ξ_{B}. Thus, a similar expression can be obtained for index assignment ξ_{A} as follows:

$$\overline{ρ ( {ξ}_{B} , {𝒬}^{O} ( {ξ}_{B} ) , {ℛ}^{O} ( {ξ}_{B} ) , {ℋ}^{O} ( {ξ}_{B} ) )} = \overline{ρ ( \begin{matrix}{ξ}_{A} , \{ {{Q}^{O} ( {ξ}_{A} )}_{{T}_{AB}^{- 1} ( i )} \} , \\ \{ {{R}^{O} ( {ξ}_{A} )}_{{T}_{AB}^{- 1} ( i )} \} , \\ \{ {{ℋ}^{O} ( {ξ}_{A} )}_{{T}_{AB}^{- 1} ( i )} \}\end{matrix} )} \leq \overline{ρ ( {ξ}_{A} , {𝒬}^{O} ( {ξ}_{A} ) , {ℛ}^{O} ( {ξ}_{A} ) , {ℋ}^{O} ( {ξ}_{A} ) )} , \qquad ( 18 )$$

and by combining the results of Equations (17) and (18), the expression of Equation (16) can be obtained.

Thus, as Equation (16) demonstrates, any given index mapping ξ(.) is equally optimal if the precoding adaptation policy Q, rate adaptation policy R, and CSIR partitioning H jointly optimize ρ̅(̅ξ̅,̅Q̅,̅R̅,̅H̅)̅ or match to the chosen CSIT index assignment ξ(.) As a result, the optimization component 400 can start with a simple index assignment 410, expressed as ξ^{O}(i)=i, such that the average system goodput ρ̅ can be optimized with respect to Q, R, and H. Therefore, it can be appreciated that P^{CSIT}=P^{DMC-FB}, which is a given matrix in the optimization problem determined by the feedback channel. As a result, ξ(.) can be removed from the average system goodput expression utilized by the optimization component 400.

Next, to achieve an optimal CSIR partitioning strategy 420, rate adaptation policy 430, and precoding adaptation policy 440, the optimization component 400 can define a modified distortion measure d(H,j) as follows:

$$d ( H , j ) = {\sum }_{j = 1}^{N} {R}_{j} \cdot 1 ( {R}_{j} < C ( H , {Q}_{j} ) ) \cdot {P}_{ij}^{CSIT} . \qquad ( 19 )$$

Based on the distortion measure given by Equation (19), the optimization problem can be written as follows:

$$\overline{ρ ( 𝒬 , ℛ , ℋ )} = {max}_{\{ 𝒬 , ℛ , ℋ \}} {\sum }_{i = 1}^{N} {ℰ}_{H} [ d ( H , i ) \vert H ∈ {ℋ}_{i} ] Pr [ H ∈ {ℋ}_{i} ] . \qquad ( 20 )$$

It should be appreciated that the optimization problem given by Equation (20) is equivalent to the classical vector quantization (VQ) problem with the modified distortion measure d(H,i). Therefore, in accordance with one aspect, a Lloyd's algorithm can be applied by the optimization component 400 as modified infra to obtain optimal strategies {Q,R} and H.

In accordance with one aspect, the optimization component 400 can determine an optimal CSIR partitioning strategy 420, rate adaptation policy 430, and precoding adaptation policy 440 based on an iterative two-step process. In the first step, given a CSIR partitioning strategy 420, the optimization component 400 can determine an optimal rate adaptation policy 430 and precoding adaptation policy 440. In the second step, given a rate adaptation policy 430 and precoding adaptation policy 440, the optimization component can determine an optimal CSIR partitioning strategy 420. These steps can be conducted as follows.

First, the optimization component 400 can determine an optimal transmission adaptation policy {{Q₁,R₁}, . . . ,{Q_{N},R_{N}}} for a given CSIR partition {H₁, . . . ,H_{N}} in the following manner. In general, given an CSIR partition such that Hᵢ and Pr[H ∈ Hᵢ] are fixed, an optimal transmission adaptation, {Qᵢ,Rᵢ}, can be found by the generalized centroid condition (CC) as follows:

$$\begin{matrix}\{ {Q}_{i} , {R}_{i} \} = arg {max}_{\{ {Q}_{1} , {R}_{1} \} , … , \{ {Q}_{N} , {R}_{N} \}} {\sum }_{i = 1}^{N} {ℰ}_{H} [ d ( H , i ) \vert H ∈ {ℋ}_{i} ] Pr [ H ∈ {ℋ}_{i} ] \\ = arg {max}_{\{ {Q}_{1} , {R}_{1} \} , … , \{ {Q}_{N} , {R}_{N} \}} {\sum }_{j = 1}^{N} {\sum }_{i = 1}^{N} {R}_{j} \cdot Pr \\ [ {R}_{j} < {log}_{2} det ( I + {HQ}_{j} {H}^{H} ) \vert H ∈ {ℋ}_{i} ] Pr [ H ∈ {ℋ}_{i} ] \cdot {P}_{ij}^{CSIT} ,\end{matrix} \qquad ( 21 )$$

such that the above described constraints in connection with P̅ᵢ̅ₓ̅ and P̅ₒ̅ᵤ̅ₜ̅ are both satisfied. As a result of this determination, a new set of precoder and rate adaptation codebooks Q*={Q*₁, . . . ,Q*_{N}}, R*={R*₁, . . . ,R*_{N}} can be produced and provided to the second step of the above determination as described below. In one example, solutions for Q* and R* can be obtained based on a “maximin” problem as described in more detail infra.

After determining transmission adaptation codebooks Q, R, the optimization component 400 can then utilize the determined codebooks to determine an optimal CSIR Partition, {H₁, . . . ,H_{N}}. In one example, based on the codebooks Q,R obtained from the previous step, the CSIR partitioning H can be optimized using the nearest neighborhood condition (NNC) as follows:

$$\begin{matrix}{ℋ}_{i}^{*} = \{ H ∈ {𝒞}^{{n}_{R} \times {n}_{T}} : d ( H , i ) \geq d ( H , k ) ; ∀ i , k ∈ \{ 1 , … , N \} , i \neq k \} \\ = \{ H ∈ {𝒞}^{{n}_{R} \times {n}_{T}} : {\sum }_{j = 1}^{N} {R}_{j} \cdot 1 ( {R}_{j} < {log}_{2} \vert {I}_{{n}_{R}} + {HQ}_{j} {H}^{H} \vert ) \cdot {P}_{ij}^{CSIT} \geq \\ {\sum }_{j = 1}^{N} {R}_{j} \cdot 1 ( {R}_{j} < {log}_{2} \vert {I}_{{n}_{R}} + {HQ}_{j} {H}^{H} \vert ) \cdot {P}_{kj} ; \\ ∀ i , k ∈ \{ 1 , … , N \} , i \neq k \} .\end{matrix} \qquad ( 22 )$$

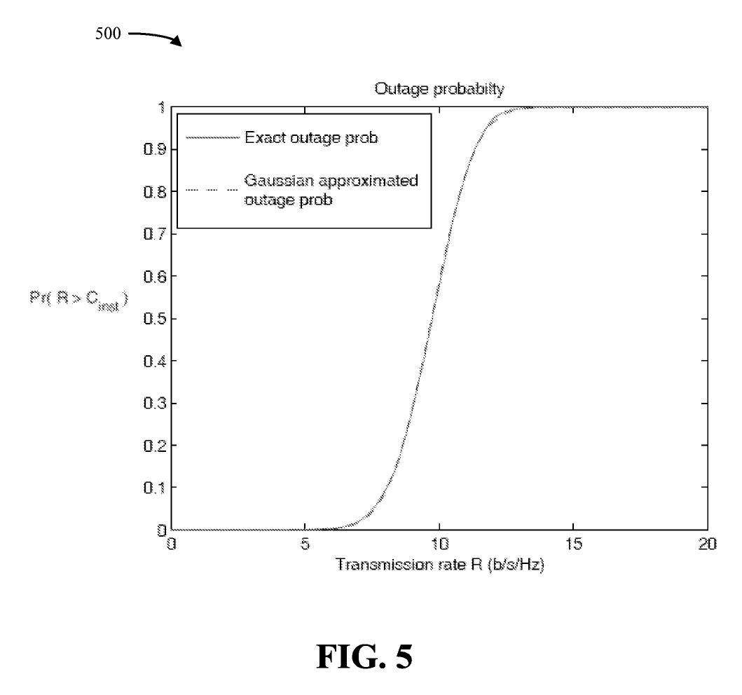

In accordance with one aspect, in view of the generalized centroid condition described above, the optimization problem for transmission adaptation codebooks Q,R can be transformed into a maximin problem such that based on the maximin theorem, an optimal solution can be derived for Q and R. In one example, the optimization component 400 can solve the maximin problem based on a model of the packet outage probability term Pr(log₂ det(I+HQⱼH^{H})<Rⱼ|H ∈ Hᵢ). Particularly, it can be observed that the instantaneous mutual information log₂ det(I+HQⱼH^{H}) can be well approximated by a Gaussian distribution for a moderate number of n_{T} and n_{R}. This is illustrated by graph 500 in FIG. 5, which shows that the actual outage probability for a communication system closely matches a Gaussian approximation of the packet outage probability. As a result, the following expression can be utilized:

$$Pr ( {log}_{2} det ( I + {HQ}_{j} {H}^{H} ) < {R}_{j} \vert H ∈ {ℋ}_{i} ) \approx Q ( \frac{{μ}_{ij} ( {Q}_{j} ) - {R}_{j}}{{σ}_{ij} ( {Q}_{j} )} ) , \qquad ( 23 )$$

where μᵢⱼ and σᵢⱼ² are the conditional mean and variance of the mutual information and can be given by:

μᵢⱼ=ε[log₂ det(I+HQⱼH^{H})|H ∈ Hᵢ] (24)

and

σᵢⱼ²=ε[(log₂ det(I+HQⱼH^{H}))²|H ∈ Hᵢ]−μᵢⱼ². (25)

In accordance with one aspect, the properties μᵢⱼ and σᵢⱼ can exhibit the following scalability with respect to average SNR. In particular, for a large transmit SNR P₀, μᵢⱼ=O(log P₀) and σᵢⱼ=O(1), where O(.) is the notation for order (e.g., asymptotic upper bound). This property can be proven as follows. First, let Qⱼ=P₀\tilde{Q}ⱼ where Σⱼ₌₁^{N}Σᵢ₌₁^{N}tr\tilde{Q}ⱼ Pr[H ∈ Hᵢ]Pᵢⱼ^{CSIT}≦1. Based on this expression, the following can be obtained:

$$\begin{matrix}{μ}_{ij} = ℰ [ {log}_{2} det ( I + {P}_{0} H {\tilde{Q}}_{j} {H}^{H} ) \vert H ∈ {ℋ}_{i} ] {\leq }^{( a )} \\ {log}_{2} det ( I + {P}_{0} {\tilde{Q}}_{j} ℰ [ {H}^{H} H \vert H ∈ {ℋ}_{i} ] ) , \\ = 𝒪 ( log {P}_{0} )\end{matrix} \qquad ( 26 )$$

where the inequality denoted as (a) is due to Jensen's inequality. It can be further observed from Equation (26) that the upper bound is asymptotically tight for large P₀. As a result, μᵢⱼ can be written as follows:

μᵢⱼ=log₂ det(I+P₀\tilde{Q}ε[H^{H}H|H ∈ Hᵢ])−O(1), (27)

where O(1) denotes a constant term that does not scale with P₀. Similarly, σᵢⱼ² can be given by the following:

$$\begin{matrix}{σ}_{ij}^{2} = ℰ [ {log}_{2}^{2} det ( I + {P}_{0} H {\tilde{Q}}_{j} {H}^{H} ) \vert H ∈ {ℋ}_{i} ] - {μ}_{ij}^{2} \\ = ℰ [ {log}_{2}^{2} det ( I + {P}_{0} H {\tilde{Q}}_{j} {H}^{H} ) \vert H ∈ {ℋ}_{i} ] - \\ {log}_{2}^{2} det ( I + {P}_{0} {\tilde{Q}}_{j} ℰ [ {HH}^{H} \vert H ∈ {ℋ}_{i} ] ) + 𝒪 ( 1 ) \leq \\ {log}_{2}^{2} det ( I + {P}_{0} {\tilde{Q}}_{j} ℰ [ {HH}^{H} \vert H ∈ {ℋ}_{i} ] ) - \\ {log}_{2}^{2} det ( I + {P}_{0} {\tilde{Q}}_{j} ℰ [ {HH}^{H} \vert H ∈ {ℋ}_{i} ] + 𝒪 ( 1 ) \\ = 𝒪 ( 1 ) .\end{matrix} \qquad ( 28 )$$

As a result of the above scalability of μᵢⱼ and σᵢⱼ, it can be appreciated that μᵢⱼ>>σᵢⱼ² for large SNR. Thus, using the above expression of actual outage probability, the conditional average packet outage can be given by the following:

$$\overline{{P}_{out}} ( j ) = \frac{\begin{matrix}{\sum }_{i = 1}^{n} Pr [ {log}_{2} \vert {I}_{{n}_{R}} + {HQ}_{j} {H}^{H} \vert < {R}_{j} \vert H ∈ {ℋ}_{i} ] \\ Pr [ H ∈ {ℋ}_{i} ] {P}_{ij}^{CSIT}\end{matrix}}{{\sum }_{i = 1}^{N} Pr [ H ∈ {ℋ}_{i} ] {P}_{ij}^{CSIT}} \approx \frac{{\sum }_{i = 1}^{N} Pr [ H ∈ {ℋ}_{i} ] {P}_{ij}^{CSIT} Q ( \frac{{μ}_{ij} ( {Q}_{j} ) - {R}_{j}}{{σ}_{ij} ( {Q}_{j} )} )}{{\sum }_{i = 1}^{N} Pr [ H ∈ {ℋ}_{i} ] {P}_{ij}^{CSIT}} . \qquad ( 29 )$$

It can be appreciated that the numerator in Equation (29) is a weighted sum of Q(x)-function (which is of exponential order with respect to x for large x) and that the target packet outage level is ε. Thus, for sufficiently small εand using the scalability of μᵢⱼ and σᵢⱼ, P̅ₒ̅ᵤ̅ₜ̅(j) can be further approximated by:

$$\overline{{P}_{out}} ( j ) \approx \frac{Pr [ H ∈ {ℋ}_{{i}^{*}} ] {P}_{{i}^{*} j}^{CSIT} Q ( \frac{{μ}_{{i}^{*} j} ( {Q}_{j} ) - {R}_{j}}{ {σ}_{{i}^{*} j} ( {Q}_{j} )} )}{{\sum }_{i = 1}^{N} Pr [ H ∈ {ℋ}_{i} ] {P}_{ij}^{CSIT}} , \qquad ( 30 )$$

where

$${i}^{*} = arg {min}_{i ∈ {ℬ}_{j}} {μ}_{ij} and {ℬ}_{j} = \{ i ∈ \{ 1 , N \} \text{:} Pr [ H ∈ {ℋ}_{i} ] {P}_{ij}^{CSIT} > ɛ \}$$

is the set of highly likely FBR i that produces FBT j. Using Equation (30), the target conditional packet outage probability constraint is equivalent to the following:

$$\overline{{P}_{out}} ( j ) = ɛ ⇔ {R}_{j} = {μ}_{{i}^{*} j} ( {Q}_{j} ) - {σ}_{{i}^{*} j} ( {Q}_{j} ) {Q}^{- 1} ( \frac{ɛ {\sum }_{i = 1}^{N} Pr [ H ∈ {ℋ}_{i} ] {P}_{ij}^{CSIT}}{Pr [ H ∈ {ℋ}_{{i}^{*}} ] {P}_{{i}^{*} j}^{CSIT}} ) . \qquad ( 31 )$$

Thus, by setting the rate codebook {Rⱼ} according to Equation (31), the optimization component 400 can satisfy the target packet outage level 450. Substituting Equation (31) and P̅ₒ̅ᵤ̅ₜ̅(j)=ε into the original optimization problem presented above, the objective function can be simplified as follows:

$${max}_{\{ {Q}_{1} , … , {Q}_{N} \}} {\sum }_{j = 1}^{N} ( 1 - ɛ ) {β}_{j} [ {μ}_{{i}^{*} j} ( {Q}_{j} ) - {σ}_{{i}^{*} j} ( {Q}_{j} ) {Q}^{- 1} ( \frac{{ɛβ}_{j}}{Pr [ H ∈ {ℋ}_{{i}^{*}} ] {P}_{{i}^{*} j}^{CSIT}} ) ] {\approx }^{( a )} {\sum }_{j = 1}^{N} {min}_{i ∈ {ℬ}_{j}} {μ}_{ij} ( {Q}_{j} ) ( 1 - ɛ ) {β}_{j} = {\sum }_{j = 1}^{N} ( 1 - ɛ ) {β}_{j} [ {min}_{i ∈ {ℬ}_{j}} ℰ [ {log}_{2} det ( I + {HQ}_{j} {H}^{H} ) \vert H ∈ {ℋ}_{i} ] ] , {\approx }^{( b )} ( 1 - ɛ ) {max}_{\{ {Q}_{1} , … , {Q}_{N} \}} {\sum }_{j = 1}^{N} {β}_{j} [ {min}_{i ∈ {ℬ}_{j}} {log}_{2} det ( I + {Q}_{j} ℰ [ {H}^{H} H \vert H ∈ {ℋ}_{i} ] ) ] \qquad ( 32 )$$

where βⱼ=Σᵢ₌₁^{N} Pr[H ∈ Hᵢ]Pᵢⱼ^{CSIT}, the first approximation in Equation (32) is due to μ_{i*j}>>σ_{i*j} for large SNR P₀, and the second approximation in Equation (32) is due to Jensen's inequality being asymptotically tight at high SNR. By taking the transmit power constraint given by Equation (14) into consideration, the Lagrangian of the optimization problem in Equation (32) with respect to Qⱼ can be given by the following:

$$L ( {Q}_{1} , … , {Q}_{N} , λ ) = ( 1 - ɛ ) {\sum }_{j = 1}^{N} {β}_{j} [ {min}_{i ∈ {ℬ}_{j}} {log}_{2} det ( I + {Q}_{j} ℰ [ {H}^{H} H \vert H ∈ {ℋ}_{i} ] ) - λ tr ( {Q}_{j} ) ] , \qquad ( 33 )$$

where λ is the Lagrange multiplier for the transmit power constraint.

As a result of the above, the joint optimization problem for {Q₁, . . . ,Q_{N}} can be given by the “maximin” problem and can be decoupled into N subproblems. In such an implementation, the j-th subproblem is given by the following:

$${max}_{{Q}_{j}} [ {min}_{i ∈ {ℬ}_{j}} {log}_{2} det ( I + {Q}_{j} ℰ [ {H}^{H} H \vert H ∈ {ℋ}_{i} ] ) - λ tr ( {Q}_{j} ) ] . \qquad ( 34 )$$

To provide robust performance, the optimization component 400 can therefore implement optimization of the precoding adaptation policy 440 as equivalent to a “maximin” problem, wherein a precoder Qⱼ is chosen to maximize the worst case mutual information over the set of all likely FBR Bⱼ.

It should be appreciated that the above maximin problem is equivalent to a strategic game based on game theory principles, where a first player (e.g., the transmitter codebook design) chooses Qⱼ to maximize the payoff Ψ(Qⱼ,i)(Ψ(Qⱼ,i)=log₂ det(I+Qⱼε[H^{H}H|H ∈ Hᵢ])−λtr(Qⱼ)), while a second player (e.g., FBR) chooses a FBR index i ∈ Bⱼ to minimize the payoff. In such a case, there can exist a set of equilibrium points (Q*ⱼ,i*), called Nash equilibrium, that are robust or optimal in the sense that no player wants to deviate from such points. Accordingly, Nash equilibrium, which can also be referred to as a saddle point, is a simultaneously optimal point for both players. The Nash equilibrium can be expressed as follows:

Ψ(Qⱼ,i*)≦Ψ(Q*ⱼ,i*)≦Ψ(Q*ⱼ,i) ∀Qⱼ [symbol] 0,i ∈ Bⱼ. (35)

According to the principles of game theory, when Nash equilibrium for a game exists, the optimal value of the game Ψ(Q*ⱼ,i*) is equal to the maximin and the minimax solutions of Equation (34), which can be expressed as the following:

$$Ψ ( {Q}_{j}^{*} , {i}^{*} ) = {max}_{{Q}_{j}} {min}_{i ∈ {ℬ}_{i}} Ψ ( {Q}_{j} , i ) = {min}_{i ∈ {ℬ}_{j}} {max}_{{Q}_{j}} Ψ ( {Q}_{j} , i ) . \qquad ( 36 )$$

As a result, a closed-form solution for Q*ⱼ can be obtained by solving the dual problem or minimax problem presented by Equation (36). However, it should be appreciated that, depending on the given CSIR partitioning H, such a closed-form solution for Q*ⱼ may or may not exist. In accordance with one aspect, a closed form solution for the maximin problem of Equation (36) exists if the following condition is met. Let (Q**ⱼ,i**) be the optimal solution of the minimax problem

$${min}_{i ∈ {ℬ}_{j}} {max}_{{Q}_{j}} Ψ ( {Q}_{j} , i ) , let ( {Q}_{j}^{*} , {i}^{*} )$$

be the optimal solution of the maximin problem

$${max}_{{Q}_{j}} {min}_{i ∈ {ℬ}_{j}} Ψ ( {Q}_{j} , i )$$

$$and let {i}^{*} ( Q ) = arg {min}_{i ∈ {ℬ}_{j}} Ψ ( Q , i ) .$$

### If

$${i}^{*} ( {Q}_{j}^{**} ) ≡ arg {min}_{i ∈ {ℬ}_{j}} Ψ ( {Q}_{j}^{**} , i ) = {i}^{**} ,$$

then it follows that there exists a saddle point solution for Equation (34). Accordingly, optimizing Qⱼ for the maximin problem can be given by:

Q*ⱼ=Q**ⱼ=W_{i**}Λ_{i**}W_{i**}^{H}, (37)

where Wᵢ and ψᵢ are the unitary eigenmatrix and the diagonal eigenvalue matrix of ε[H^{H}H|H ∈ Hᵢ], respectively, Λᵢ is the power water-filling diagonal matrix given by

$${Λ}_{i} = {[ \frac{I}{λ} - {ψ}_{i}^{- 1} ]}^{+} , \qquad ( 38 )$$

and i** is given by

$${i}^{**} ≡ arg {min}_{i ∈ {ℬ}_{j}} {max}_{{Q}_{j}} Ψ ( {Q}_{j} , i ) = arg {min}_{i ∈ {ℬ}_{j}} {\sum }_{n = 1}^{min \{ {n}_{T} , {n}_{R} \}} \{ {[ {log}_{2} ( \frac{{ψ}_{i} ( n , n )}{λ} ) ]}^{+} - {λψ}_{i} ( n , n ) \} , \qquad ( 39 )$$

In one example, the above condition can be proven as follows. First, let (Q*ⱼ,i*) be the optimal solution of the maximin problem max min Ψ(Qⱼ,i). Using this definition, it can be appreciated that the optimal value Ψ(Q*ⱼ,i*) is upper-bounded by the minimax value. This can be expressed as follows:

$$Ψ ( {Q}_{j}^{*} , {i}^{*} ) = {max}_{{Q}_{j}} {min}_{i ∈ {ℬ}_{j}} Ψ ( {Q}_{j} , i ) \leq {min}_{i ∈ {ℬ}_{j}} {max}_{{Q}_{j}} Ψ ( Q , i ) = Ψ ( {Q}_{j}^{**} , {i}^{**} ) . \qquad ( 40 )$$

On the other hand, it can be further observed that Ψ(Q*ⱼ,i*) is lower-bounded by the following:

$$Ψ ( {Q}_{j}^{*} , {i}^{*} ) = {max}_{{Q}_{j}} {min}_{i ∈ {ℬ}_{j}} Ψ ( {Q}_{j} , i ) \geq {min}_{i ∈ {ℬ}_{j}} Ψ ( {Q}_{j} , i ) = Ψ ( {Q}_{j} , {i}^{*} ( {Q}_{j} ) ) ∀ {Q}_{j} ≽ 0. \qquad ( 41 )$$

By setting Qⱼ=Q**ⱼ in Equation (41) and combining Equation (41) with Equation (40), the following can be obtained:

Ψ(Q**ⱼ,i*(Q**ⱼ))≦Ψ(Qⱼ**,i*)≦Ψ(Q**ⱼ,i**). (42)

As a result, if

$${i}^{*} ( {Q}_{j}^{**} ) ≡ arg {min}_{i ∈ {ℬ}_{j}} Ψ ( {Q}_{j}^{**} , i ) = {i}^{**} ,$$

the upper bound equals the lower bound and the optimization solution for Q*ⱼ can be given by the minimax (dual problem) solution Q**ⱼ. In such a case, the minimax solution can be obtained by first solving the inner maximization problem with respect to Q for a given i. Thus, for example,

$${Q}_{j}^{**} ( i ) = arg {max}_{{Q}_{j}} Ψ ( {Q}_{j} , i )$$

can be obtained using standard optimization techniques and singular value decomposition (SVD). Next, i** can be obtained by solving the outer minimization problem

$${i}^{**} = arg {min}_{i ∈ {ℬ}_{j}} g ( i )$$

over the discrete set Bⱼ where

g(i)=Ψ(Q**ⱼ(i),i).

In one example, if the above condition is not satisfied for a given CSIR partition H, it is possible for the minimax solution to not equal the maximin solution. In such a case, the maximin problem can be solved directly by the optimization component 400 by using a subgradient method in convex optimization. In accordance with one aspect, a subgradient matrix of a function is defined as follows. Let f:Cⁿ^{_{T}}^{×n}^{_{T}}→ [symbol] be a concave real-valued function of an n_{T}×n_{T} matrix. Thus, a matrix S ∈ Cⁿ^{_{T}}^{×n}^{_{T}} is said to be a subgradient matrix of f at a point X ∈ Cⁿ^{_{T}}^{×n}^{_{T}} if the following condition is met:

f(Z)≦f(X)+(Z=X)S^{H} ∀Z ∈ Cⁿ^{_{T}}^{×n}^{_{T}}. (43)

Based on the above definition of a subgradient matrix, the optimization component 400 can solve the maximin problem based on the subgradient method as follows. First,

$$f ( {Q}_{j} ) = arg {min}_{i ∈ {ℬ}_{j}} Ψ ( {Q}_{j} , i )$$

can be obtained by solving the inner minimization problem of the maximin problem in Equation (34). Since Ψ(Qⱼ,i) is a concave function with respect to Qⱼ for all i ∈ Bⱼ, it therefore follows that f(Qⱼ) is also a concave function in Qⱼ. Moreover, since Ψ(Qⱼ,i) is differentiable in Qⱼ for all i ∈ Bⱼ, the subgradient matrix S(Qⱼ) of f(Qⱼ) can be given by the following:

S(Qⱼ)=∇_{Q}_{ⱼ} Ψ(Qⱼ,i*(Qⱼ))=(I+Qⱼε[H^{H}H|H ∈ Hᵢ])⁻¹−λI, (44)

where

$${i}^{*} ( {Q}_{j} ) = {min}_{i ∈ {ℬ}_{j}} Ψ ( {Q}_{j} , i ) .$$

Based on the above,

$${Q}_{j}^{*} = arg {max}_{{Q}_{j}} f ( {Q}_{j} )$$

can then be obtained iteratively based on the subgradient method as follows:

Qⱼ(t+1)=[Qⱼ(t)+α(t)S^{H}(Qⱼ(t))]⁺, (45)

where t is the index of iterative steps, [A]⁺denotes a projection of the Hermitian matrix A onto the space of positive semi-definite matrices such that the sum of eigenvalues is equal to 1, and α>0 is a positive step size.

While successive iterations of the subgradient method may not improve the value of the objective function, it should be appreciated that since f(Qⱼ) is a concave function and Qⱼ [symbol] 0 is a convex constraint, the subgradient method as described above is guaranteed to converge to an optimal solution Q*ⱼ provided α(t) is appropriately set. For example, α(t)=(1+m)/(t+m) for some m>0 can be utilized as a diminishing step size rule that guarantees convergence.

In light of the above description, the optimization component 400 in accordance with various aspects described herein can provide a robust joint rate, power and precoder design for MIMO slow fading channels with noisy limited feedback. By doing so, the optimization component 400 optimizes the goodput (b/s/Hz successfully delivered to the receiver) of an associated communication system with respect to a general model of limited feedback error. In one example, the optimization component can be implemented without introducing additional system overhead above that which would be required for conventional naive feedback designs and/or conventional precoder designs.

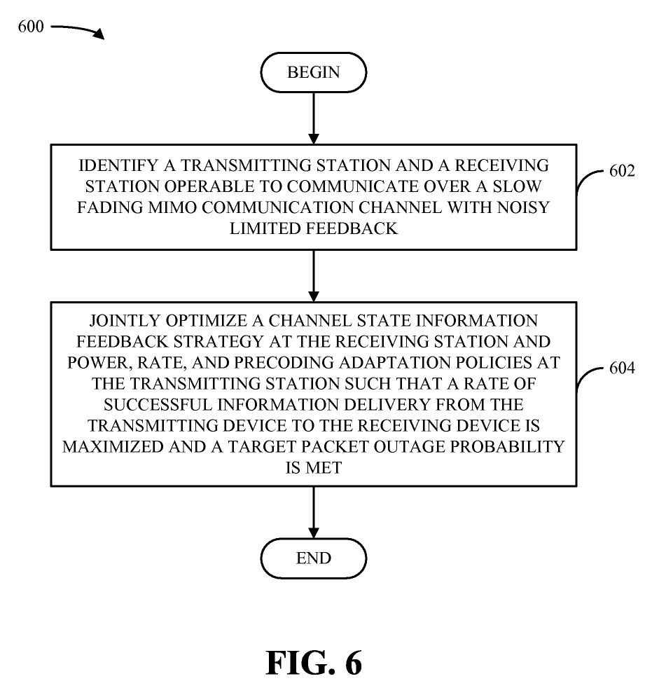

Referring now to FIGS. 6-9, methodologies that can be implemented in accordance with various aspects described herein are illustrated. While, for purposes of simplicity of explanation, the methodologies are shown and described as a series of blocks, it is to be understood and appreciated that the claimed subject matter is not limited by the order of the blocks, as some blocks may, in accordance with the claimed subject matter, occur in different orders and/or concurrently with other blocks from that shown and described herein. Moreover, not all illustrated blocks may be required to implement the methodologies in accordance with the claimed subject matter.

Furthermore, the claimed subject matter may be described in the general context of computer-executable instructions, such as program modules, executed by one or more components. Generally, program modules include routines, programs, objects, data structures, etc., that perform particular tasks or implement particular abstract data types. Typically the functionality of the program modules may be combined or distributed as desired in various embodiments. Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

Referring to FIG. 6, a method 600 of adapting parameters of stations (e.g., a transmitting station 110 and/or a receiving station 120) operating in a wireless communication system (e.g., system 100) is illustrated. At 602, a transmitting station and a receiving station are identified that are operable to communicate over a slow fading MIMO communication channel (e.g., a communication channel 130) with noisy limited feedback. At 604, joint optimization is performed (e.g., by an optimization component 140) for a CSI feedback strategy at the receiving station identified at 602 and power, rate, and precoding adaptation policies at the transmitting station identified at 602 such that a rate of successful information delivery from the transmitting device to the receiving device (e.g., system goodput) is maximized and a target packet outage probability is met.

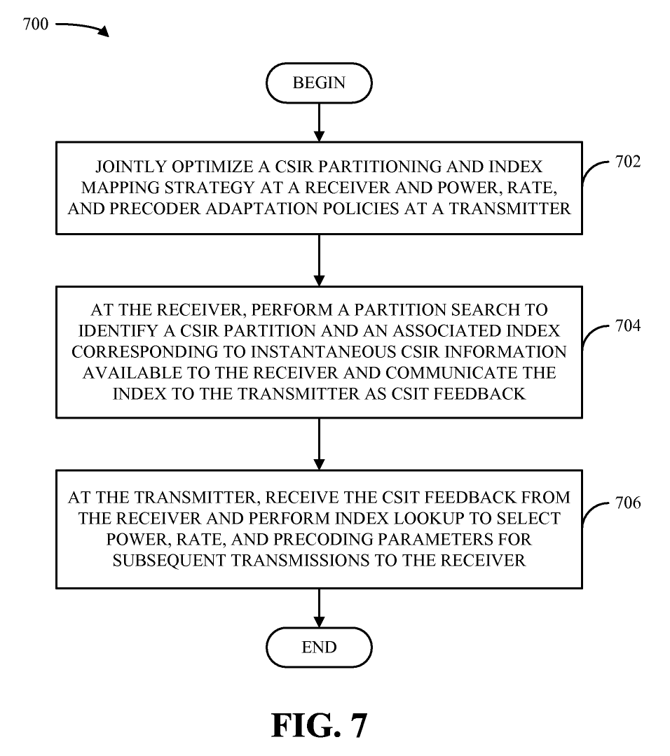

Turning now to FIG. 7, a flowchart of a method 700 of facilitating optimized communication in a wireless communication system (e.g., system 300) is provided. At 702, a CSIR partitioning and index mapping strategy (e.g., a CSIT feedback index mapping 326 and a CSIR partitioning scheme 327) at a receiver (e.g., a receiver 320) and power, rate, and precoding adaptation policies (e.g., rate adaptation policy 316 and power/precoding adaptation policy 317) at a transmitter (e.g., a transmitter 310) are jointly optimized (e.g., by respective offline optimization components 320 and 310).

At 704, a partition search is performed at the receiver (e.g., by a feedback partition search component 324) to identify a CSIR partition and an associated index from the CSIR partitioning and index mapping strategy determined at 702 that corresponds to instantaneous CSIR information available to the receiver. Upon identification of the CSIR partition and associated index, the index is transmitted as CSIT feedback to the transmitter. At 706, the CSIT feedback transmitted at 704 is received by the transmitter. Based on this feedback, the transmitter performs an index lookup (e.g., via an online lookup component 314) to select power, rate, and precoding parameters from the adaptation policies determined at 702 to be used for subsequent transmissions to the receiver.

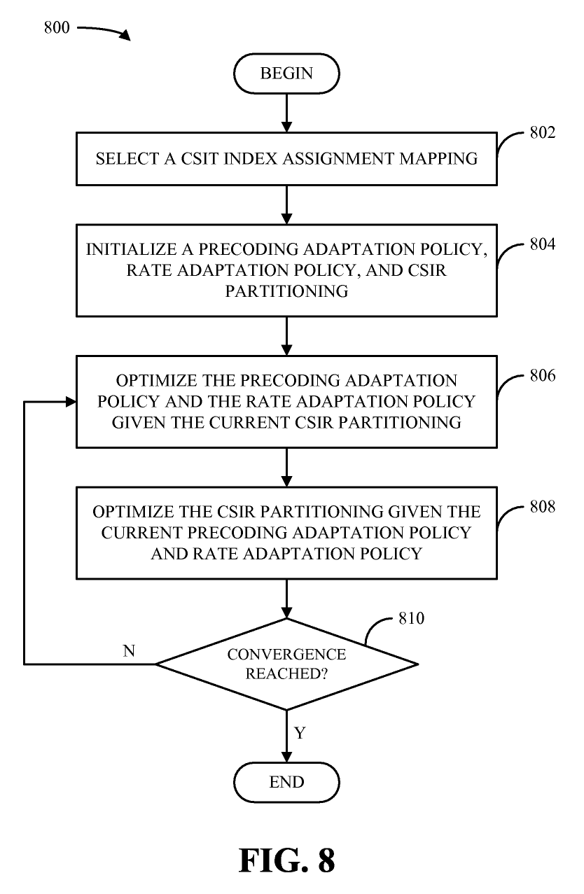

FIG. 8 illustrates a method 800 of jointly optimizing rate adaptation, precoder adaptation, and feedback strategies (e.g., for a transmitting station 110 and a receiving station 120 in a wireless communication system 100). At 802, a CSIT index assignment mapping (e.g., a CSIT feedback index mapping 410) is selected. At 804, a precoding adaptation policy (e.g., a precoding adaptation policy 440), rate adaptation policy (e.g., a rate adaptation policy 430), and CSIR partitioning (e.g., CSIR partitioning strategy 420) are initialized. At 806, the precoding adaptation policy and rate adaptation policy are optimized given the current CSIR partitioning. At 808, the CSIR partitioning is then optimized given the precoding and rate adaptation policies optimized at 806.

In one example, the acts described at 806 and 808 can be performed iteratively. Thus, at 810, it can be determined whether a convergence condition has been reached. If convergence has been reached, method 800 concludes. Otherwise, method 800 returns to 806 to repeat the optimizations.

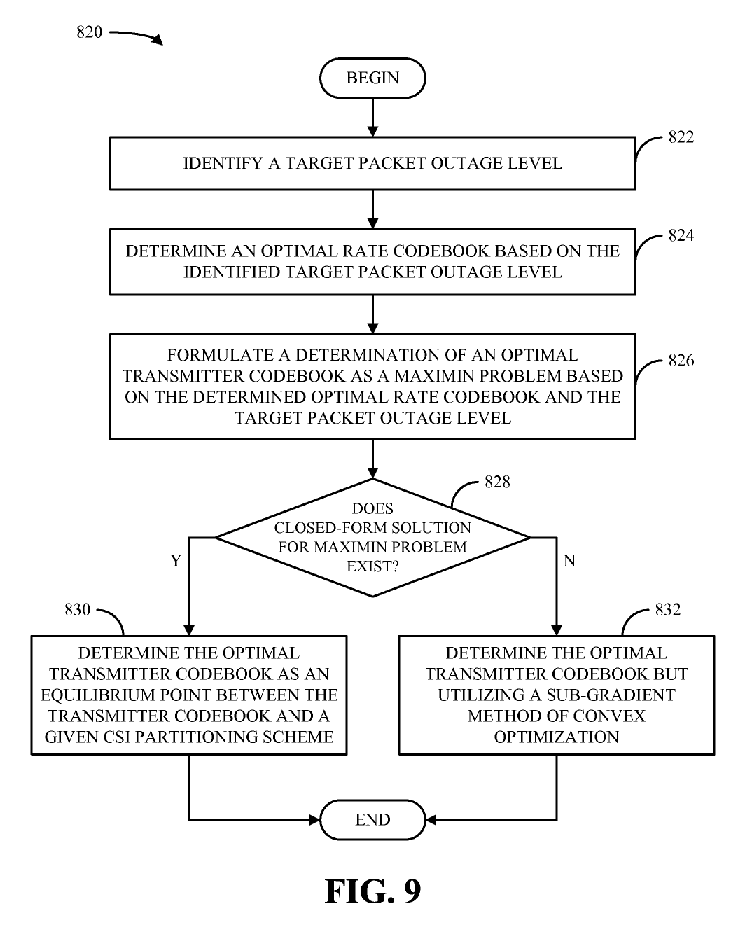

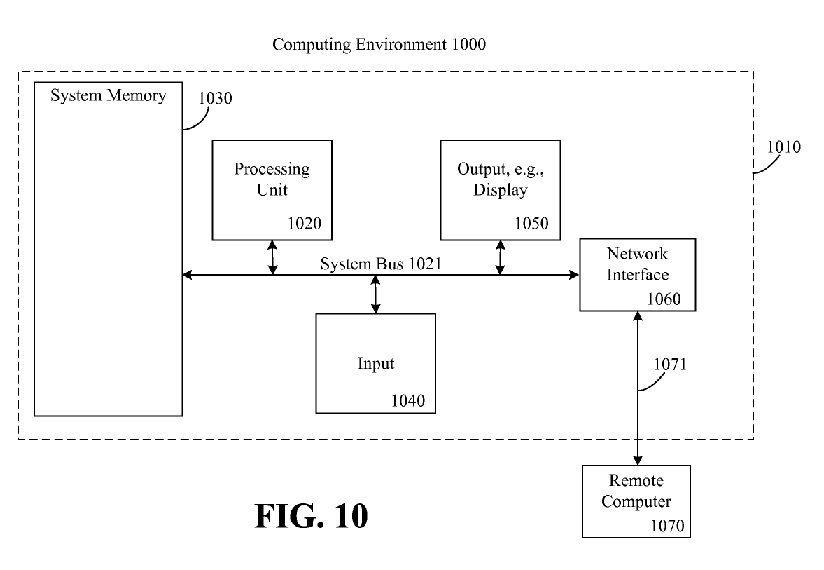

Referring to FIG. 9, an additional method 820 of jointly optimizing rate adaptation, precoder adaptation, and feedback strategies is illustrated. Method 820 can be used, for example, to perform the acts described at block 806 in method 800. Method 820 begins at 822, wherein a target packet outage level (e.g., a target packet outage level 450) is identified. At 824, an optimal rate codebook is determined based on the target packet outage level identified at 822. At 826, determination of an optimal transmitter codebook is formulated as a maximin problem based on the optimal rate codebook determined at 824 and the target packet outage level identified at 822. At 828, it is determined whether a closed-form solution for the maximin problem formulated at 826 exists. If so, method 820 concludes at 830, wherein the optimal transmitter codebook is determined as an equilibrium point between the transmitter codebook and a given channel state information (CSI) partitioning scheme. Otherwise, method 820 concludes at 832, wherein the optimal transmitter codebook is determined using a sub-gradient method of convex optimization.

Turning to FIG. 10, an exemplary non-limiting computing system or operating environment in which various aspects described herein can be implemented is illustrated. One of ordinary skill in the art can appreciate that handheld, portable and other computing devices and computing objects of all kinds are contemplated for use in connection with the claimed subject matter, e.g., anywhere that a communications system may be desirably configured. Accordingly, the below general purpose remote computer described below in FIG. 10 is but one example of a computing system in which the claimed subject matter can be implemented.

Although not required, the claimed subject matter can partly be implemented via an operating system, for use by a developer of services for a device or object, and/or included within application software that operates in connection with one or more components of the claimed subject matter. Software may be described in the general context of computer-executable instructions, such as program modules, being executed by one or more computers, such as client workstations, servers or other devices. Those skilled in the art will appreciate that the claimed subject matter can also be practiced with other computer system configurations and protocols.

FIG. 10 thus illustrates an example of a suitable computing system environment 1000 in which the claimed subject matter can be implemented, although as made clear above, the computing system environment 1000 is only one example of a suitable computing environment for a media device and is not intended to suggest any limitation as to the scope of use or functionality of the claimed subject matter. Further, the computing environment 1000 is not intended to suggest any dependency or requirement relating to the claimed subject matter and any one or combination of components illustrated in the example operating environment 1000.

With reference to FIG. 10, an example of a remote device for implementing various aspects described herein includes a general purpose computing device in the form of a computer 1010. Components of computer 1010 can include, but are not limited to, a processing unit 1020, a system memory 1030, and a system bus 1021 that couples various system components including the system memory to the processing unit 1020. The system bus 1021 can be any of several types of bus structures including a memory bus or memory controller, a peripheral bus, and a local bus using any of a variety of bus architectures.

Computer 1010 can include a variety of computer readable media. Computer readable media can be any available media that can be accessed by computer 1010. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1010. Communication media can embody computer readable instructions, data structures, program modules or other data in a modulated data signal such as a carrier wave or other transport mechanism and can include any suitable information delivery media.

The system memory 1030 can include computer storage media in the form of volatile and/or nonvolatile memory such as read only memory (ROM) and/or random access memory (RAM). A basic input/output system (BIOS), containing the basic routines that help to transfer information between elements within computer 1010, such as during start-up, can be stored in memory 1030. Memory 1030 can also contain data and/or program modules that are immediately accessible to and/or presently being operated on by processing unit 1020. By way of non-limiting example, memory 1030 can also include an operating system, application programs, other program modules, and program data.

The computer 1010 can also include other removable/non-removable, volatile/nonvolatile computer storage media. For example, computer 1010 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 1021 through a non-removable memory interface such as an interface, and a magnetic disk drive or optical disk drive can be connected to the system bus 1021 by a removable memory interface, such as an interface.

A user can enter commands and information into the computer 1010 through input devices such as a keyboard or a pointing device such as a mouse, trackball, touch pad, and/or other pointing device. Other input devices can include a microphone, joystick, game pad, satellite dish, scanner, or the like. These and/or other input devices can be connected to the processing unit 1020 through user input 1040 and associated interface(s) that are coupled to the system bus 1021, but can be connected by other interface and bus structures, such as a parallel port, game port or a universal serial bus (USB). A graphics subsystem can also be connected to the system bus 1021. In addition, a monitor or other type of display device can be connected to the system bus 1021 via an interface, such as output interface 1050, which can in turn communicate with video memory. In addition to a monitor, computers can also include other peripheral output devices, such as speakers and/or a printer, which can also be connected through output interface 1050.

The computer 1010 can operate in a networked or distributed environment using logical connections to one or more other remote computers, such as remote computer 1070, which can in turn have media capabilities different from device 1010. The remote computer 1070 can be a personal computer, a server, a router, a network PC, a peer device or other common network node, and/or any other remote media consumption or transmission device, and can include any or all of the elements described above relative to the computer 1010. The logical connections depicted in FIG. 10 include a network 1071, such local area network (LAN) or a wide area network (WAN), but can also include other networks/buses. Such networking environments are commonplace in homes, offices, enterprise-wide computer networks, intranets and the Internet.

When used in a LAN networking environment, the computer 1010 is connected to the LAN 1071 through a network interface or adapter. When used in a WAN networking environment, the computer 1010 can include a communications component, such as a modem, or other means for establishing communications over the WAN, such as the Internet. A communications component, such as a modem, which can be internal or external, can be connected to the system bus 1021 via the user input interface at input 1040 and/or other appropriate mechanism. In a networked environment, program modules depicted relative to the computer 1010, or portions thereof, can be stored in a remote memory storage device. It should be appreciated that the network connections shown and described are exemplary and other means of establishing a communications link between the computers can be used.

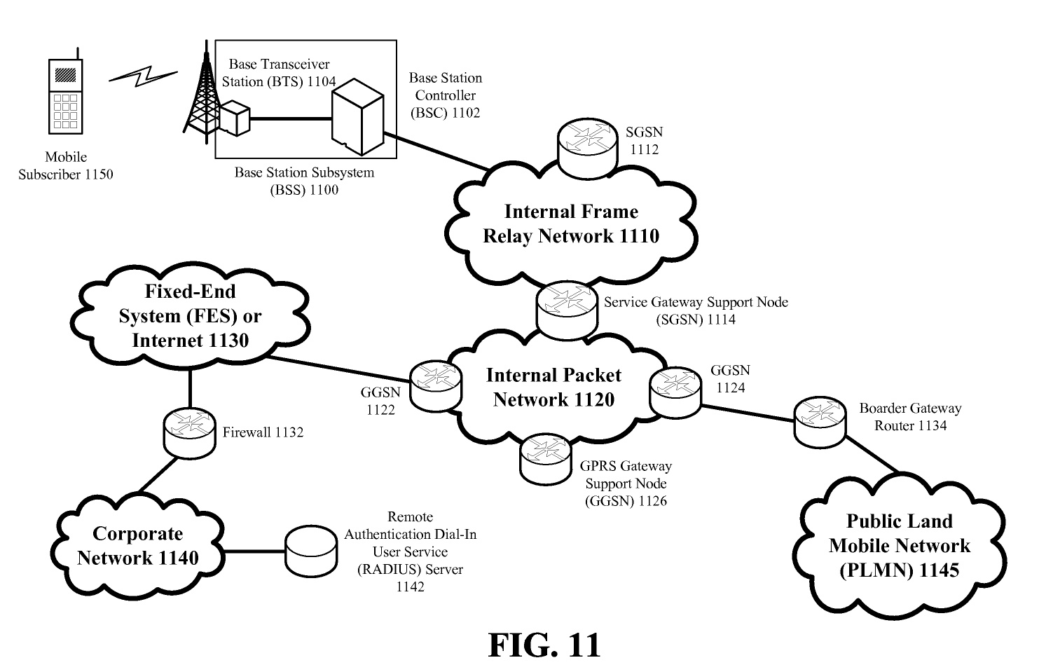

Turning now to FIG. 11, an overview of a network environment in which the claimed subject matter can be implemented is illustrated. The above-described systems and methodologies can be applied to any wireless communication network; however, the following description sets forth an exemplary, non-limiting operating environment for said systems and methodologies. The below-described operating environment should be considered non-exhaustive, and thus the below-described network architecture is merely an example of a network architecture into which the claimed subject matter can be incorporated. It is to be appreciated that the claimed subject matter can be incorporated into any now existing or future alternative communication network architectures as well.

Referring back to FIG. 11, various aspects of the global system for mobile communication (GSM) are illustrated. GSM is one of the most widely utilized wireless access systems in today's fast growing communications systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the timing synchronization techniques described herein may be applied independently of the method of data transport, and does not depend on any particular network architecture or underlying protocols.

FIG. 11 depicts an overall block diagram of an exemplary packet-based mobile cellular network environment, such as a GPRS network, in which the claimed subject matter can be practiced. Such an environment can include a plurality of Base Station Subsystems (BSS) 1100 (only one is shown), each of which can comprise a Base Station Controller (BSC) 1102 serving one or more Base Transceiver Stations (BTS) such as BTS 1104. BTS 1104 can serve as an access point where mobile subscriber devices 1150 become connected to the wireless network. In establishing a connection between a mobile subscriber device 1150 and a BTS 1104, one or more timing synchronization techniques as described supra can be utilized.

In one example, packet traffic originating from mobile subscriber 1150 is transported over the air interface to a BTS 1104, and from the BTS 1104 to the BSC 1102. Base station subsystems, such as BSS 1100, are a part of internal frame relay network 1110 that can include Service GPRS Support Nodes (“SGSN”) such as SGSN 1112 and 1114. Each SGSN is in turn connected to an internal packet network 1120 through which a SGSN 1112, 1114, etc., can route data packets to and from a plurality of gateway GPRS support nodes (GGSN) 1122, 1124, 1126, etc. As illustrated, SGSN 1114 and GGSNs 1122, 1124, and 1126 are part of internal packet network 1120. Gateway GPRS serving nodes 1122, 1124 and 1126 can provide an interface to external Internet Protocol (“IP”) networks such as Public Land Mobile Network (“PLMN”) 1145, corporate intranets 1140, or Fixed-End System (“FES”) or the public Internet 1130. As illustrated, subscriber corporate network 1140 can be connected to GGSN 1122 via firewall 1132; and PLMN 1145 can be connected to GGSN 1124 via boarder gateway router 1134. The Remote Authentication Dial-In User Service (“RADIUS”) server 1142 may also be used for caller authentication when a user of a mobile subscriber device 1150 calls corporate network 1140.

Generally, there can be four different cell sizes in a GSM network—macro, micro, pico, and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

The claimed subject matter has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Additionally, the disclosed subject matter can be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g., according to a hierarchical arrangement. Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but generally known by those of skill in the art.

What is claimed is:

1. A system for facilitating optimized communication in a wireless communication system, comprising:
at least one wireless transmitter;
at least one wireless receiver communicatively connected to the wireless transmitter via one or more slow fading multiple-input multiple-output (MIMO) communication channels with noisy limited feedback; and
an optimization component that jointly designs rate, power, and precoder adaptation policies for the wireless transmitter and a feedback strategy for the wireless receiver to maximize a rate of successful information delivery from the wireless transmitter to the wireless receiver.

2. The system of claim 1, wherein the feedback strategy comprises a channel state information of receiver (CSIR) partitioning scheme comprising one or more channel state partitions and a channel state information of transmitter (CSIT) feedback index mapping that maps channel state partitions in the CSIR partitioning scheme to respective indices.

3. The system of claim 2, wherein the optimization component jointly designs the jointly designs rate, power, and precoder adaptation policies and the feedback strategy at least in part by selecting an initial CSIT feedback index mapping and utilizing iterative optimizations to select the rate, power, and precoder adaptation strategies and the CSIR partitioning scheme.

4. The system of claim 3, wherein the optimization component selects the rate, power, and precoder adaptation strategies and the CSIR partitioning scheme at least in part by utilizing a vector quantization technique based on a modified distortion measure.

5. The system of claim 3, wherein the optimization component converts optimization of the precoder adaptation policy to an equivalent maximin equation that addresses error constraints introduced by noisy limited feedback received on a noisy feedback channel.

6. The system of claim 5, wherein the optimization component optimizes the precoder adaptation policy at least in part by selecting a point that represents a Nash equilibrium for the maximin equation between the precoder adaptation policy and the feedback strategy.

7. The system of claim 5, wherein the optimization component optimizes the precoder adaptation policy at least in part by solving the maximin equation using a sub-gradient method of convex optimization.

8. The system of claim 3, wherein the optimization component optimizes the rate adaptation policy at least in part by selecting a rate adaptation policy that causes the wireless communication system to satisfy a target packet outage probability.

9. The system of claim 1, wherein the wireless transmitter comprises an offline optimization component that facilitates selection of optimal rate, power, and precoding adaptation policies and an online lookup component that utilizes the rate, power, and precoding adaptation policies to configure one or more communications with a wireless receiver based on feedback received from the wireless receiver and one or more table lookup functions.

10. The system of claim 1, wherein the wireless receiver comprises an offline optimization component that facilitates selection of an optimal CSIR partitioning scheme and CSIT feedback index mapping and a online partition search component that identifies a CSIR partition from the CSIR partitioning scheme that corresponds to channel state information available to the wireless receiver, associates the CSIR partition with an index from the CSIT feedback index mapping, and facilitates communication of the index as feedback to a wireless transmitter.

11. A method of for providing rate, power and precoder adaptation for a slow fading MIMO communication channel with noisy limited feedback, comprising:
identifying a transmitting station and a receiving station operable to communicate over a slow fading MIMO communication channel with noisy limited feedback; and
jointly optimizing a set of CSIR partitions and a set of corresponding CSIT indices at the receiving station and power, rate, and precoder codebooks at the transmitting station such that a system goodput between the transmitting station and the receiving station is maximized and a target packet error probability is met.

12. The method of claim 11, wherein the optimizing comprises:
initializing the set of CSIR partitions, the set of CSIT indices, and the power, rate, and precoder codebooks; and
iteratively optimizing the set of CSIR partitions and the power, rate, and precoder codebooks until a convergence condition is reached.

13. The method of claim 12, wherein the iteratively optimizing the set of CSIR partitions and the power, rate, and precoder codebooks comprises iteratively optimizing the set of CSIR partitions and the power, rate, and precoder codebooks using a vector quantization algorithm based at least in part on a modified distortion measure.

14. The method of claim 13, wherein the iteratively optimizing the set of CSIR partitions and the power, rate, and precoder codebooks comprises:
determining an optimal rate codebook based at least in part on a target packet error probability; and
determining an optimal precoder codebook by formulating and solving a maximin problem based on the determined optimal rate codebook and the target packet error probability.

15. The method of claim 14, wherein the determining an optimal precoder codebook comprises determining the optimal precoder codebook as an equilibrium point for the maximin equation between the precoder codebook and the set of CSIR partitions.

16. The method of claim 14, wherein the determining an optimal precoder codebook comprises determining the optimal precoder codebook at least in part by solving the maximin problem using a sub-gradient technique for convex optimization.

17. The method of claim 11, further comprising:
performing a partition search operation at the receiving station to identify a CSIR partition from the optimized set of CSIR partitions and a corresponding CSIT index from the optimized set of CSIT indices based at least in part on instantaneous channel state information available at the receiving station; and
communicating the identified CSIT index as feedback to the transmitting station over a noisy feedback channel.

18. The method of claim 11, further comprising:
receiving a CSIT index at the transmitting station, the CSIT index is transmitted as feedback by the receiving station over a noisy feedback channel; and
performing an index lookup operation to determine respective entries in the optimized rate, power, and precoder codebooks corresponding to the received CSIT index.

19. A computer-readable medium having stored thereon instructions operable to perform the method of claim 11.

20. A system that facilitates rate, power, preceding, and feedback optimization for a wireless communication system, comprising:
means for identifying at least one wireless transmitter and at least one wireless receiver operable to communicate over a slow fading MIMO channel with noisy limited feedback;
means for identifying one or more error characteristics relating to the slow fading MIMO channel; and
means for jointly providing power, rate, precoding, and feedback adaptation for the at least one wireless transmitter and the at least one wireless receiver such that a system goodput for the slow fading MIMO channel is optimized based at least in part on the error characteristics relating to the slow fading MIMO channel.
